(19) United States
(12) Patent Application Publication
(10) Pub. No.: US 2025/0386087 A1
(43) Pub. Date: Dec. 18, 2025

(54) VEHICULAR CAMERA

(71) Applicant: Panasonic Automotive Systems Co., Ltd., Kanagawa (JP)

(72) Inventor: Yoshiyuki HASHIMOTO, Kanagawa (JP)

(73) Assignee: Panasonic Automotive Systems Co., Ltd., Kanagawa (JP)

(21) Appl. No.: 19/233,920

(22) Filed: Jun. 10, 2025

(30) Foreign Application Priority Data
Jun. 12, 2024 (JP) 2024-095165

(51) Int. Cl. H04N 23/51; B60R 1/27; H04N 23/54; H04N 23/55

(52) U.S. Cl. CPC H04N 23/51; B60R 1/27; H04N 23/54; H04N 23/55; B60R 2300/105

(57) ABSTRACT

A vehicular camera includes a lens barrel having inner and outer side surfaces, and a lens, an imaging element, a circuit board, a housing, and a ring member facing at least a part of the third end portion of the housing and accommodating the imaging element and the circuit board together with the housing. In a first welded portion, a first portion of the ring member and at least a part of the third end portion of the housing are welded. In a second welded portion, a second portion of the ring member and at least a part of the second end portion of the lens barrel are welded. The first welded portion is located outside a part of the outer side surface of the lens barrel, and the second welded portion is located inside the part of the outer side surface of the lens barrel.

### TECHNICAL FIELD

The present disclosure relates to a vehicular camera.

### BACKGROUND ART

In recent years, with the demand for improved vehicle safety, the introduction of autonomous driving functions, and the like, there has been active development of vehicular cameras that are mounted on a vehicle and capture images of the inside and outside of the vehicle (for example, see Patent Literatures 1 and 2).

### CITATION LIST

### Patent Literature

Patent Literature 1: WO2024/004821
Patent Literature 2: JP2022-185553A

### SUMMARY OF INVENTION

Required levels relating to safety, autonomous driving functions, and the like, which are required for vehicles, are improved, and further improvement in performance and the like are also required for vehicular cameras.

The present disclosure relates to a technique for providing a new vehicular camera.

The present disclosure provides a vehicular camera. The vehicular camera includes a lens barrel including an inner side surface and an outer side surface, having a first tubular shape along an optical axis, and including a first end portion, a second end portion opposite to the first end portion, and at least one lens disposed along the optical axis; an imaging element disposed on the optical axis and is placed closer to the second end portion of the lens barrel than to the first end portion of the first tubular shape of the lens barrel; a circuit board including a first surface and a second surface opposite to the first surface, the imaging element being disposed on the first surface; a housing enclosing at least the imaging element and the circuit board, having a second tubular shape along the optical axis, and including a third end portion and a fourth end portion that is farther than the third end portion with respect to the first end portion of the lens barrel and is disposed opposite to the third end portion; a ring member facing at least a part of the second end portion of the lens barrel and at least a part of the third end portion of the housing, and accommodating at least the imaging element and the circuit board together with the housing; a first welded portion in which a first portion of the ring member and the at least a part of the third end portion of the housing are welded over an entire periphery around the optical axis, the first portion being disposed over the entire periphery around the optical axis; and a second welded portion in which a second portion of the ring member and the at least a part of the second end portion of the lens barrel are welded over the entire periphery around the optical axis, the second portion being disposed over the entire periphery around the optical axis. The second end portion of the lens barrel has a first light absorptance, the third end portion of the housing has a second light absorptance, the ring member has a third light absorptance, the third light absorptance is smaller than the first light absorptance and smaller than the second light absorptance, the first portion of the ring member is disposed closer to the third end portion of the housing than to the fourth end portion of the housing, the second portion of the ring member is disposed closer to the second end portion of the lens barrel than to the fourth end portion of the housing, the first welded portion is located outside a part of the outer side surface of the lens barrel with respect to the optical axis, and the second welded portion is located inside the part of the outer side surface of the lens barrel with respect to the optical axis.

According to the present disclosure, even if diameters of the lens and the lens barrel increase in order to improve imaging performance, it is possible to perform welding at the first welded portion and the second welded portion from the same direction, and it is possible to prevent an assembly step from becoming complicated while preventing an increase in the size of the vehicular camera.

### BRIEF DESCRIPTION OF DRAWINGS

FIG. 1 is an example of a vehicle, and is a top view of a vehicle on which vehicular cameras are mounted;

FIG. 2 is a block diagram illustrating a connection example of the vehicular cameras, a camera ECU, and a display provided in the vehicle illustrated in FIG. 1;

FIG. 3 is another example of the vehicle, and is a schematic diagram of a vehicle interior of the vehicle on which vehicular cameras are mounted;

FIG. 4 is a top view of the vehicle in FIG. 3;

FIG. 5 is a block diagram illustrating a connection example of the vehicular camera, the camera ECU, and a display device provided in the vehicle illustrated in FIG. 3;

FIG. 6 is a top perspective view of the vehicular camera according to an embodiment;

FIG. 7 is a bottom perspective view of the vehicular camera according to the embodiment;

FIG. 8 is an exploded perspective view of the vehicular camera according to the embodiment;

FIG. 9 is a top view of the vehicular camera according to the embodiment;

FIG. 10 is a cross-sectional view taken along a line I-I in FIG. 9;

FIG. 11 is an enlarged view of a region A in FIG. 10;

FIG. 12 is an enlarged view of a region B in FIG. 10;

FIG. 13 is a perspective view of a lens barrel viewed from a second end portion side;

FIG. 14A is a perspective view of a ring member viewed from a third surface side;

FIG. 14B is a perspective view of the ring member viewed from a fourth surface side;

FIG. 15 is a perspective view illustrating a state in which the lens barrel and the ring member are welded by laser welding to assemble a first assembly;

FIG. 16 is a perspective view of the first assembly and a first shield;

FIG. 17A is a top perspective view of a second assembly in which the first assembly and the first shield are assembled;

FIG. 17B is a bottom perspective view of the second assembly in which the first assembly and the first shield are assembled;

FIG. 18 is a perspective view of the second assembly and a circuit board with an imaging element;

FIG. 19 is a perspective view of a third assembly in which the second assembly and the circuit board are assembled;

FIG. 20 is a perspective view of a housing accommodating the second shield;

FIG. 21 is a perspective view of the third assembly and the housing; and

FIG. 22 is a perspective view illustrating a state in which the third assembly and the housing are welded by laser welding to assemble the vehicular camera.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following description and to facilitate understanding of those skilled in the art. It should be noted that the accompanying drawings and the following description are provided for those skilled in the art to sufficiently understand the present disclosure, and are not intended to limit the subject matter described in the claims.

(Vehicle on which Vehicular Cameras are Mounted)

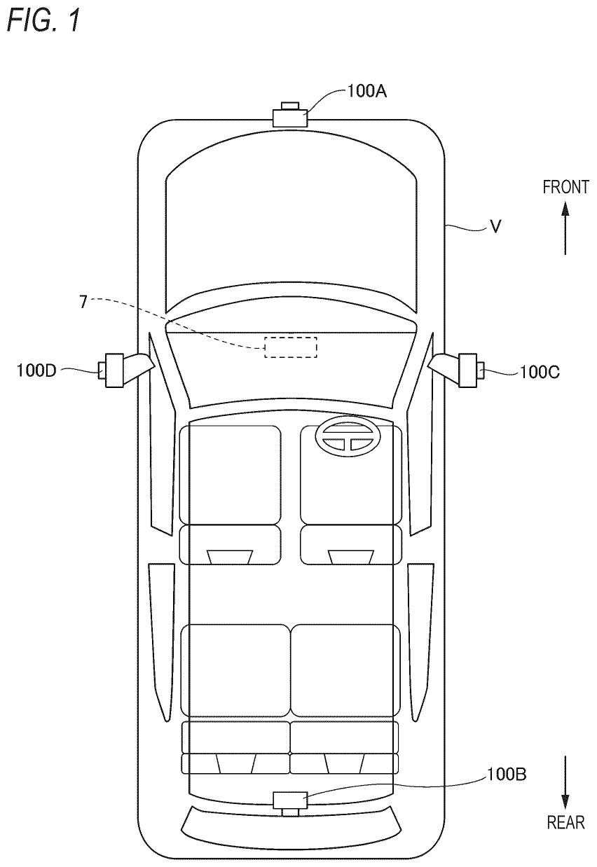

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images showing an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

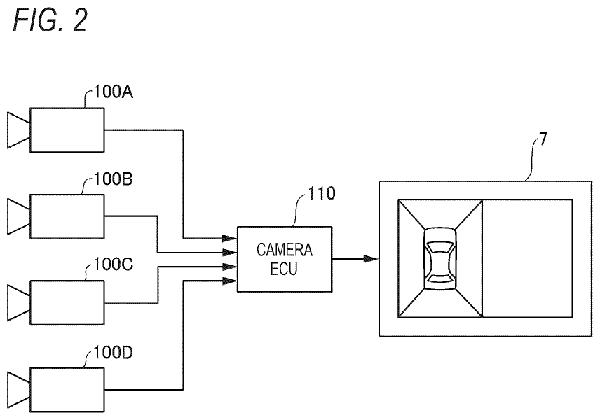

FIG. 2 is a block diagram illustrating a connection example of the vehicular cameras 100A to 100D, a camera ECU 110, and a display 7 provided in the vehicle V illustrated in FIG. 1. The camera electronic control unit (ECU) 110 in FIG. 2 synthesizes the images captured by the vehicular cameras 100A to 100D, and displays a synthesized image on the display 7 of a navigation system disposed on, for example, an instrument panel. An occupant can visually recognize the display 7 and check a situation around the vehicle V.

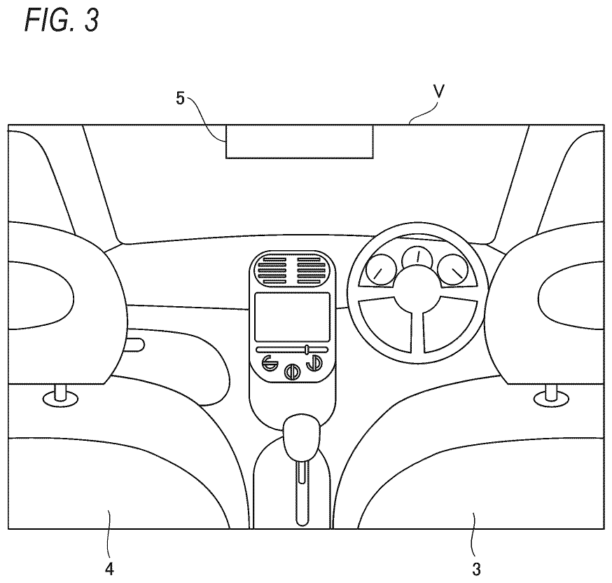

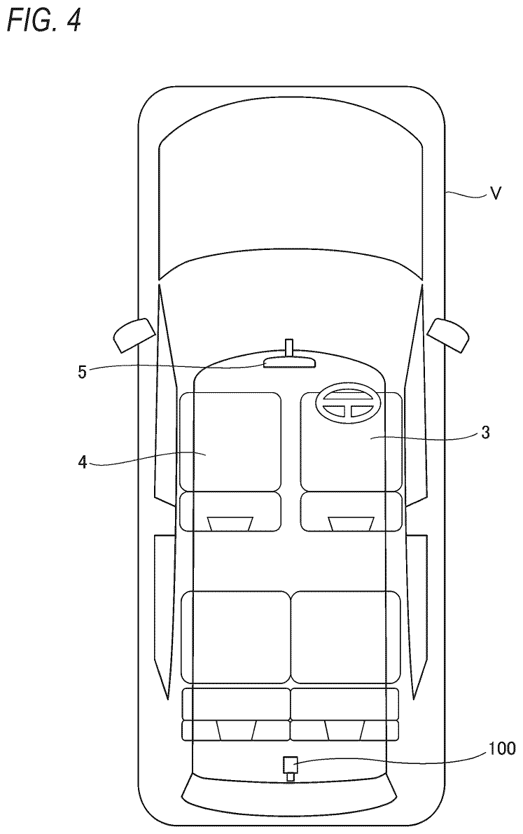

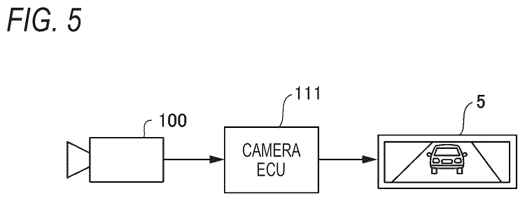

FIG. 3 is another example of the vehicle, and is a schematic diagram of a vehicle interior of the vehicle on which the vehicular camera is mounted, and FIG. 4 is a top view of the vehicle in FIG. 3. The vehicle V includes a display device 5 (for example, an electronic rearview mirror) at an attachment position of a rearview mirror, which is a front portion between a driver's seat 3 and a passenger seat 4 in a vehicle interior 2. Further, the vehicle Vis provided with the vehicular camera 100 at a rear side of a vehicle body. FIG. 5 is a block diagram illustrating a connection example of the vehicular camera 100, a camera ECU 111, and the display device 5 provided in the vehicle V illustrated in FIG. 3. The camera electronic control unit (ECU) 111 in FIG. 4 processes an image captured by the vehicular camera 100, and the display device 5 displays the image. The occupant can visually recognize the display device 5 and check a rear situation of the vehicle V.

### (Vehicular Camera)

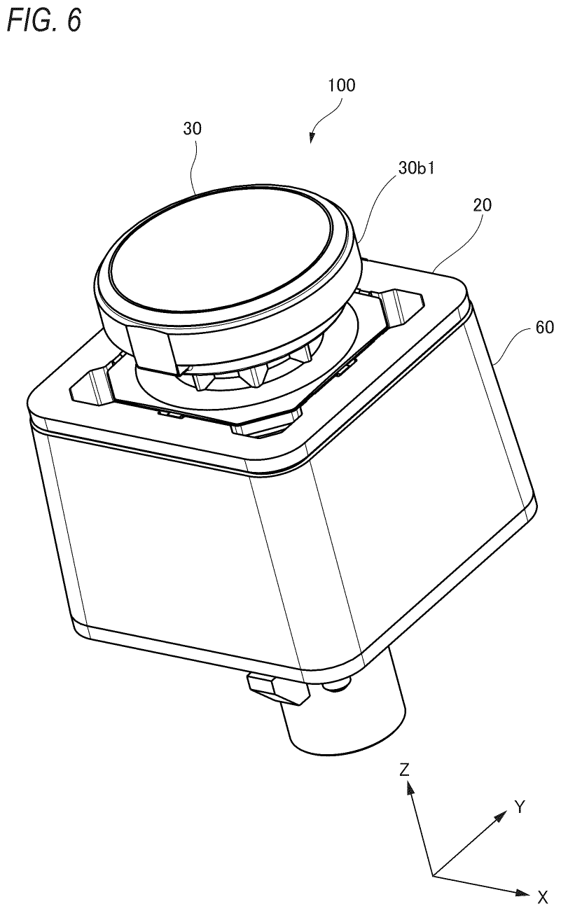

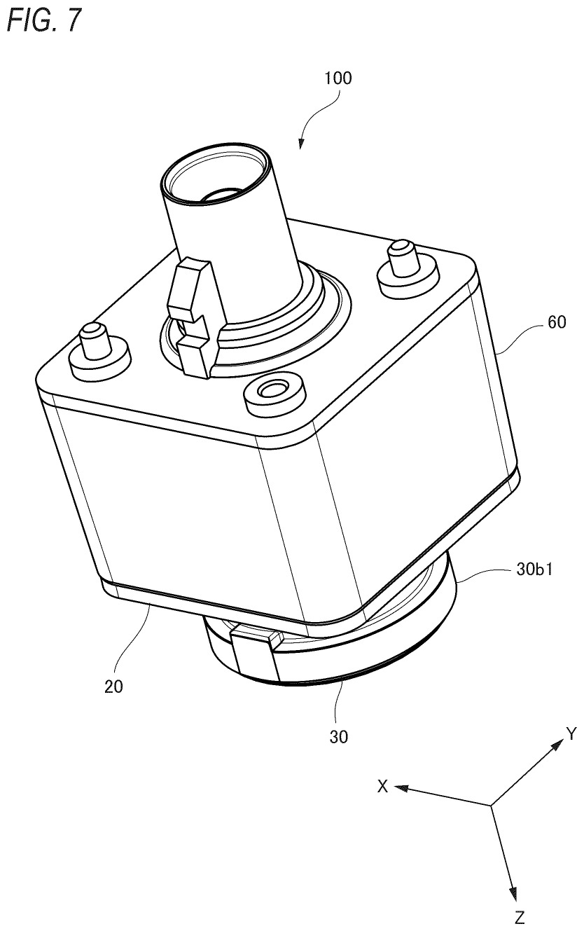

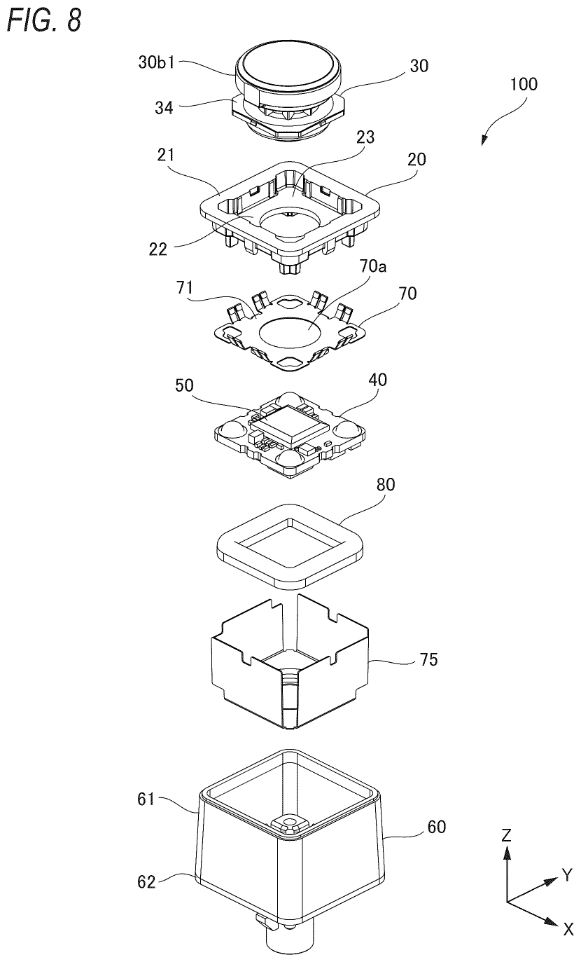

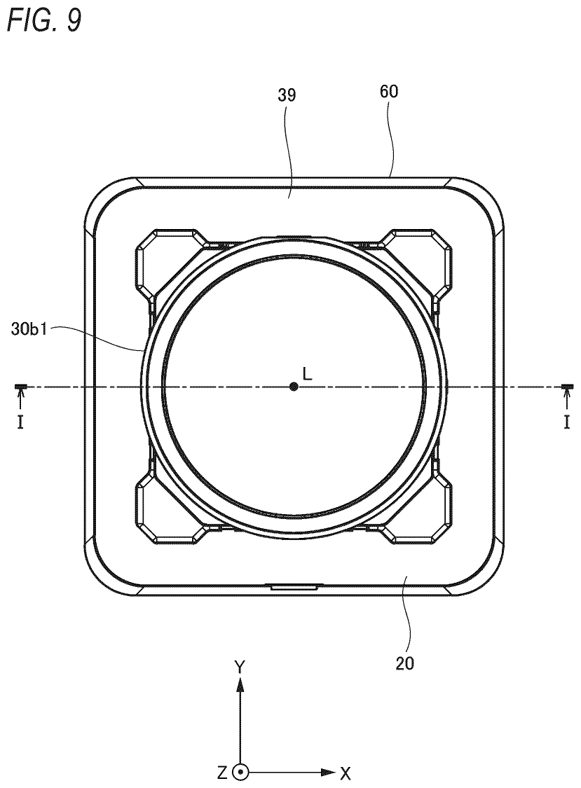

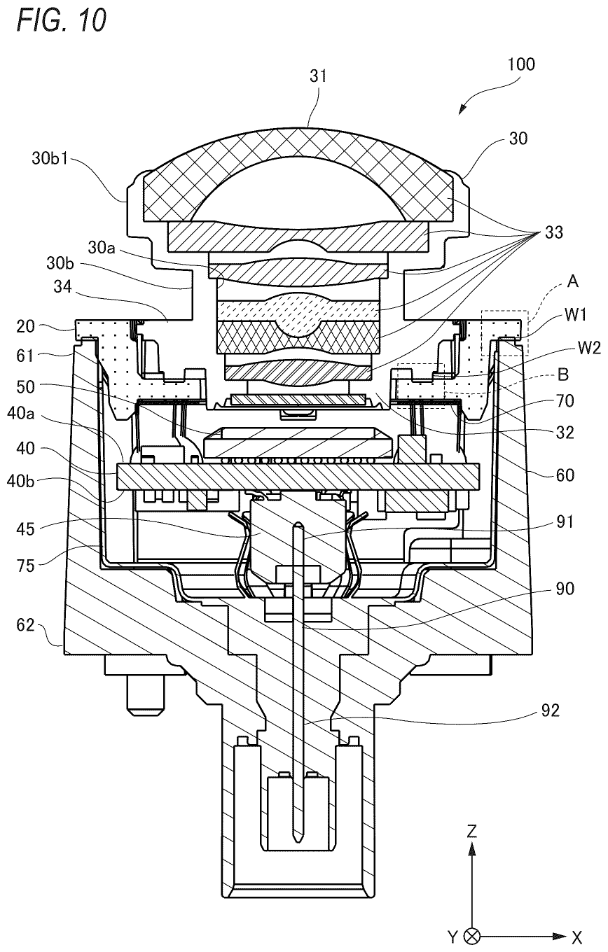

FIG. 6 is a top perspective view of the vehicular camera 100 according to the embodiment. FIG. 7 is a bottom perspective view of the vehicular camera 100 according to the embodiment. FIG. 8 is an exploded perspective view of the vehicular camera 100 according to the embodiment. FIG. 9 is a top view of the vehicular camera 100 according to the embodiment. FIG. 10 is a cross-sectional view taken along a line I-I in FIG. 9. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a lens barrel 30, an imaging element 50, a circuit board 40, and a housing 60.

The lens barrel 30 has a first tubular shape along an optical axis L extending in a direction (Z direction) perpendicular to a paper surface of FIG. 9, and includes an inner side surface 30a facing an internal space and an outer side surface 30b exposed to the outside. The lens barrel 30 has a first end portion 31 located at a tip of the vehicular camera 100 and a second end portion 32 opposite to the first end portion 31. The lens barrel 30 is made of, for example, a resin.

The lens barrel 30 includes at least one lens 33 disposed on the optical axis L. As illustrated in FIG. 10, the lens barrel 30 may accommodate, for example, a lens group including a plurality of lenses 33 therein. An end portion of each lens in the lens group is held in the internal space of the lens barrel 30 while being in contact with the inner side surface 30a. The plurality of lenses 33 are arranged in a state in which respective optical axes L are aligned with each other, and constitute the lens group used for capturing images of the inside and outside of the vehicle body of the vehicle V.

The imaging element 50 is disposed on the optical axis L and is closer to the second end portion 32 of the lens barrel 30 than to the first end portion 31 of the first tubular shape of the lens barrel 30. Light guided to the lens barrel 30 from the outside passes through the lenses 33 and reaches the imaging element 50. The imaging element 50 detects the reached light and captures an image.

The circuit board 40 includes a first surface 40a and a second surface 40b opposite to the first surface 40a, and the imaging element 50 is disposed on the first surface 40a. However, two or more circuit boards may be provided.

The housing 60 surrounds at least the imaging element 50 and the circuit board 40, has a second tubular shape along an optical axis L, and includes a third end portion 61 closer to the lens barrel 30, and a fourth end portion 62 farther than the third end portion 61 with respect to the first end portion 31 of the lens barrel 30 and disposed opposite to the third end portion 61. The housing 60 is made of, for example, a resin.

The housing 60 has, for example, a quadrangular shape in a plan view (a plan view viewed from a direction along the optical axis L, the same applies hereinafter). However, the shape in plan view may be a polygon other than a pentagon, or may be a triangle. Corner portions of the housing 60 may be curved surfaces.

The ring member 20 faces at least a part of the second end portion 32 of the lens barrel 30 and at least a part of the third end portion 61 of the housing 60, and accommodates at least the imaging element 50 and the circuit board 40 together with the housing 60. The ring member 20 is made of, for example, a resin.

The ring member 20 has a first portion 21 and a second portion 22 disposed over the entire periphery around the optical axis L. The first portion 21 is disposed outside the second portion 22 with respect to the optical axis L.

In the vehicular camera 100, the first portion 21 of the ring member 20 and at least a part of the third end portion 61 of the housing 60 have a first welded portion W1 welded over the entire periphery around the optical axis L (see FIG. 10). Further, in the vehicular camera 100, the second portion 22 of the ring member 20 and the at least a part of the second end portion 32 of the lens barrel 30 have a second welded portion W2 welded over the entire periphery around the optical axis L (see FIG. 10). In FIG. 10, a resin member 80 is omitted.

That is, the ring member 20 is welded to the housing 60 at the first welded portion W1 and welded to the lens barrel 30 at the second welded portion W2. Accordingly, the lens barrel 30, the ring member 20, and the housing 60 are integrated.

In the integrated state, the first portion 21 of the ring member 20 is disposed closer to the third end portion 61 of the housing 60 than to the fourth end portion 62 of the housing 60. The second portion 22 of the ring member 20 is disposed closer to the second end portion 32 of the lens barrel 30 than to the fourth end portion 62 of the housing 60.

Further, the first welded portion W1 is located outside a part of the outer side surface 30b of the lens barrel 30, here, a part 30b1 protruding outward near the first end portion 31 with respect to the optical axis L. The second welded portion W2 is located inside the part 30b1 of the outer side surface 30b of the lens barrel 30 with respect to the optical axis L.

Next, light absorptance of each of the lens barrel 30, the housing 60, and the ring member 20 will be described. At least the second end portion 32 of the lens barrel 30 has a first light absorptance. The first light absorptance is, for example, a light absorptance of 95% or more with respect to the light in the wavelength range of 350 nm to 1200 nm. The entire lens barrel 30 may have the first light absorptance.

At least the third end portion 61 of the housing 60 has a second light absorptance. The second light absorptance is, for example, a light absorptance of 95% or more with respect to the light in the wavelength range of 350 nm to 1200 nm. The entire housing 60 may have the second light absorptance.

On the other hand, the ring member 20 has a third light absorptance. The third light absorptance is, for example, a light absorptance of less than 85% for light having a wavelength of 1070 nm, which is the wavelength of the laser light used in laser welding, at a thickness of 1 mm, in other words, a light transmittance of 15% or more. Further, the light transmissivity of the ring member 20 is, for example, a light transmittance of 0% or more and 5% or less with respect to light of 350 nm to 700 nm, which is a wavelength range of visible light.

In the present embodiment, the third light absorptance of the ring member 20 is smaller than the first light absorptance (third light absorptance<first light absorptance) and smaller than the second light absorptance (third light absorptance<second light absorptance).

A vehicular camera in the related art is also assembled by integrating a lens barrel, a ring member, and a housing. For the welding of each member, for example, laser welding performed by irradiating a welded portion with a laser is used. The welding includes welding between the lens barrel and the ring member and welding between the ring member and the housing at two positions, and these two kinds of welding are performed by irradiating the respective welded portions with lasers. Since it is complicated to change a laser irradiation direction by a laser irradiation apparatus, each laser is generally irradiated from the same direction (for example, from top to bottom in FIG. 10).

In recent years, high imaging accuracy is required for vehicular cameras, and along with this requirement, the diameters of the lenses and the lens barrel that accommodate the lenses are increasing. When the above-described welding at two positions is located outside an outer peripheral surface of the lens barrel with respect to the optical axis L, not only the diameter of the lens barrel increases but also the size of the entire vehicular camera increases. Therefore, it is conceivable that at least one of the welding at two positions (for example, the welded portion between the lens barrel and the ring member) is located inside the outer peripheral surface of the lens barrel with respect to the optical axis L.

However, when the welding is performed at two positions by laser irradiation from the same direction, the welding at a position shifted inward from the outer peripheral surface of the lens barrel may be impossible because the increased outer peripheral surface of the lens barrel becomes an obstacle to laser traveling. There is also a method in which a laser is refracted by an optical member such as a lens and a mirror and guided to the position of the welded portion, but the accuracy of an irradiation position may be reduced.

On the other hand, in the vehicular camera 100 according to the embodiment, the first portion 21 of the ring member 20 and the at least a part of the third end portion 61 of the housing 60 are welded at the first welded portion W1, and the second portion 22 of the ring member 20 and the at least a part of the second end portion 32 of the lens barrel 30 are welded at the second welded portion W2. The first welded portion W1 is located outside the part 30b1 of the outer side surface 30b of the lens barrel 30 with respect to the optical axis L, and the second welded portion W2 is located inside the part 30b1 of the outer side surface 30b of the lens barrel 30 with respect to the optical axis L. That is, the position of the first welded portion W1 at which the ring member 20 and the housing 60 are welded and the position of the second welded portion W2 at which the ring member 20 and the lens barrel 30 are welded can be shifted inside and outside the lens barrel 30 in a radial direction orthogonal to the optical axis L.

Accordingly, even if the diameters of the lens 33 and the lens barrel 30 increase in order to improve imaging performance, the second welded portion W2 is located inside the part 30b1 of the outer side surface 30b of the lens barrel 30 with respect to the optical axis L, thereby preventing the size of the vehicular camera 100 from increasing. Further, in an assembly step, after the lens barrel 30 and the ring member 20 are laser welded from one direction at the second welded portion W2, the assembly of the lens barrel 30 and the ring member 20 is reversed, and the ring member 20 and the housing 60 can be welded at the first welded portion W1 by the laser welding from the same direction. As a result, it is possible to perform welding at the first welded portion W1 and the second welded portion W2 from the same direction, and it is possible to prevent the assembly step from becoming complicated while preventing an increase in the size of the vehicular camera 100.

The third light absorptance of the ring member 20 is smaller than the first light absorptance of the lens barrel 30 (third light absorptance<first light absorptance) and smaller than the second light absorptance of the housing 60 (third light absorptance<second light absorptance). Therefore, after the laser in the laser welding passes through the ring member 20, since the transmission thereof is prevented by the lens barrel 30 or the housing 60, the welding between the ring member 20 and the lens barrel 30 or the welding between the ring member 20 and the housing 60 can be efficiently performed. The assembly step of the vehicular camera 100 will be described in detail later.

In the present embodiment, the second welded portion W2 is closer to the fourth end portion 62 of the housing 60 than the first welded portion W1 in the direction along the optical axis L. Accordingly, the welding of the ring member 20 and the lens barrel 30 can be performed at a position different from the welding of the ring member 20 and the housing 60 in the direction along the optical axis L.

Further, the part 30b1 of the outer side surface 30b of the lens barrel 30 is the farthest from the optical axis L on the outer side surface 30b. Accordingly, the first welded portion W1 can be reliably disposed outside the outer side surface 30b of the lens barrel 30.

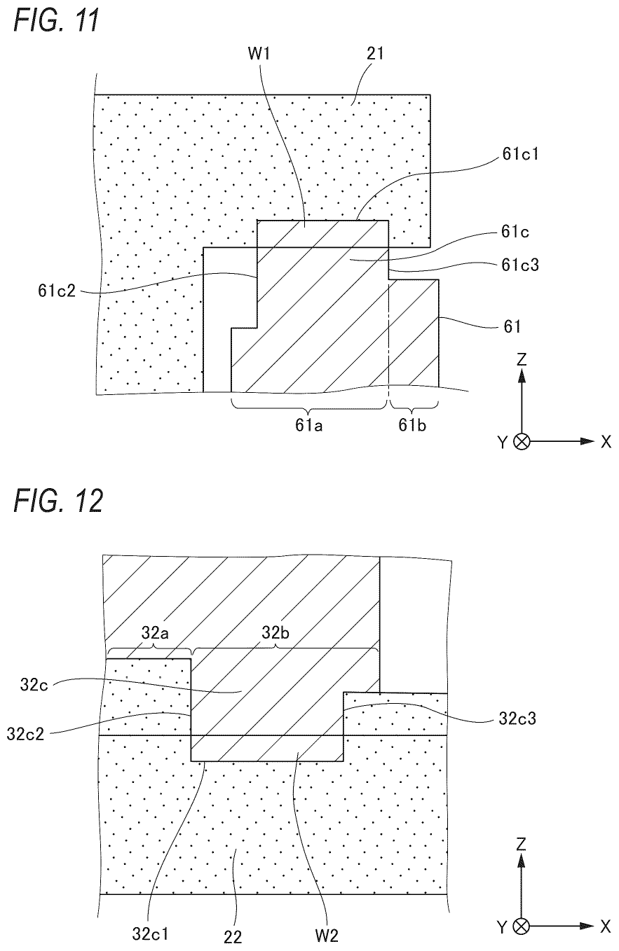

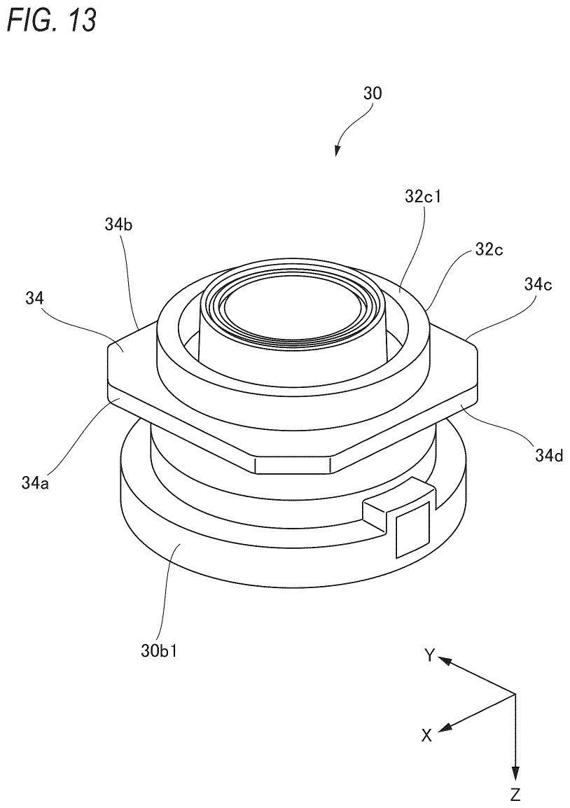

FIG. 11 is an enlarged view of a region A in FIG. 10, and FIG. 12 is an enlarged view of a region B in FIG. 10. The second end portion 32 of the lens barrel 30 includes a first region 32a, a second region 32b, and a lens barrel protruding portion 32c. The first region 32a is disposed over the entire periphery around the optical axis L, and the second region 32b is disposed outside the first region 32a with respect to the optical axis L over the entire periphery around the optical axis L. The lens barrel protruding portion 32c protrudes from the second region 32b in a direction away from the first end portion 31 of the lens barrel 30, and is disposed over the entire periphery around the optical axis L.

The lens barrel protruding portion 32c includes a lens barrel protruding top portion 32cl which is a top portion, a first lens barrel protruding side surface 32c2, and a second lens barrel protruding side surface 32c3. The first lens barrel protruding side surface 32c2 is connected to the lens barrel protruding top portion 32cl and the first region 32a, and is disposed over the entire periphery around the optical axis L. The second lens barrel protruding side surface 32c3 is connected to at least the lens barrel protruding top portion 32c1, and is disposed opposite to the first lens barrel protruding side surface 32c2 over the entire periphery around the optical axis L.

The third end portion 61 of the housing 60 includes a third region 61a, a fourth region 61b, and a housing protruding portion 61c. The third region 61a is disposed over the entire periphery around the optical axis L. The fourth region 61b is disposed outside the third region 61a with respect to the optical axis L over the entire periphery around the optical axis L. The housing protruding portion 61c protrudes from the third region 61a in a direction away from the third end portion 61 of the housing 60, and is disposed over the entire periphery around the optical axis L.

The housing protruding portion 61c includes a housing protruding top portion 61c1 that is a top portion, a first housing protruding side surface 61c2, and a second housing protruding side surface 61c3. The first housing protruding side surface 61c2 is connected to at least the housing protruding top portion 61cl and is disposed over the entire periphery around the optical axis L. The second housing protruding side surface 61c3 is connected to the housing protruding top portion 61cl and the fourth region 61b of the third end portion 61 of the housing 60, and is disposed opposite to the first housing protruding side surface 61c2 over the entire periphery around the optical axis L.

In this configuration, the at least a part of the third end portion 61 of the housing 60 is the housing protruding top portion 61cl of the housing protruding portion 61c, and the at least a part of the second end portion 32 of the lens barrel 30 is the lens barrel protruding top portion 32cl of the lens barrel protruding portion 32c.

The first welded portion W1 is formed by welding the first portion 21 of the ring member 20 and the housing protruding top portion 61cl of the housing protruding portion 61c of the third end portion 61 of the housing 60 over the entire periphery around the optical axis L, the first portion 21 being disposed over the entire periphery around the optical axis L. Further, the second welded portion W2 is formed by welding the second portion 22 of the ring member 20 and the lens barrel protruding top portion 32cl of the lens barrel protruding portion 32c of the second end portion 32 of the lens barrel 30 over the entire periphery around the optical axis L, the second portion 22 being disposed over the entire periphery around the optical axis L.

Accordingly, the first portion 21 of the ring member 20 and the housing protruding top portion 61c1 of the housing protruding portion 61c of the third end portion 61 of the housing 60 are welded at the first welded portion W1, and the second portion 22 of the ring member 20 and the lens barrel protruding top portion 32cl of the lens barrel protruding portion 32c of the second end portion 32 of the lens barrel 30 are welded at the second welded portion W2. Accordingly, the two welded portions are reliably formed, and the ring member 20 and the housing 60, and the ring member 20 and the lens barrel 30 can be firmly connected.

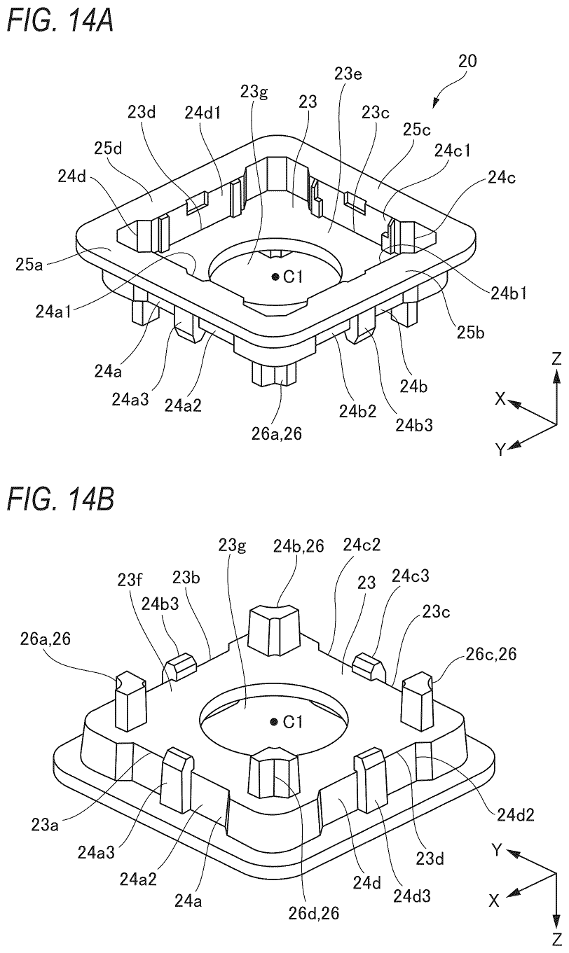

Further, the lens barrel 30 has a flange portion 34 disposed on the outside of the first tubular shape to extend outward with respect to the optical axis L over the entire periphery around the optical axis L. As illustrated in FIG. 13 to be described later, the flange portion 34 has a first shape having a first end surface 34a corresponding to a first side, a second end surface 34b corresponding to a second side, a third end surface 34c corresponding to a third side, and a fourth end surface 34d corresponding to a fourth side in a plan view of the flange portion 34. The first shape is, for example, an octagon as in the embodiment, but may be a quadrangle or another polygon. Since the lens barrel 30 has the flange portion 34, the flange portion 34 can be used for connection with the ring member 20.

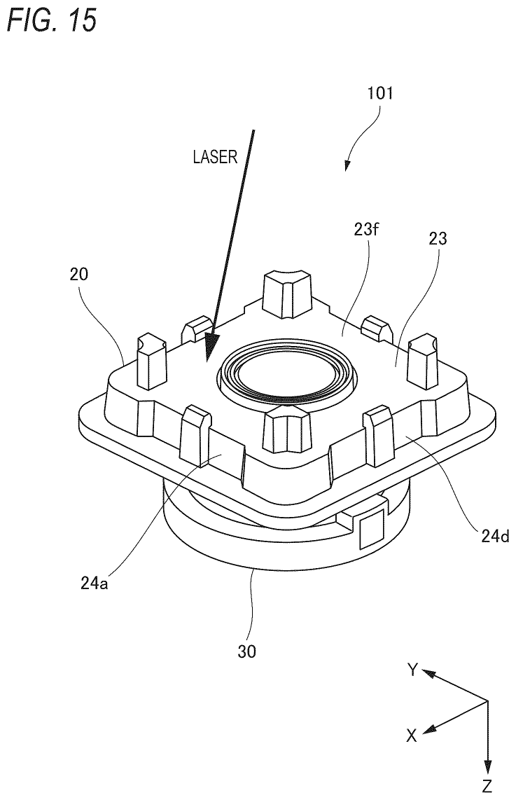

As illustrated in FIGS. 14A and 14B to be described later, the ring member 20 includes a planar portion 23, a first wall portion 24a, a second wall portion 24b, a third wall portion 24c, a fourth wall portion 24d, a first surface portion 25a, a second surface portion 25b, a third surface portion 25c, and a fourth surface portion 25d. The planar portion 23 has a first side 23a, a second side 23b connected to the first side 23a, a third side 23c connected to the second side 23b, and a fourth side 23d connected to the third side 23c, and has a second shape in plan view of the ring member 20. The second shape is, for example, a quadrangle, but may be a polygon having five or more sides. At least a part of the planar portion 23 includes the first portion 21.

The first wall portion 24a extends from the first side 23a of the planar portion 23 in a direction away from the fourth end portion 62 of the housing 60, and has a first inner side surface 24a1 and a first outer side surface 24a2 opposite to the first inner side surface 24a1. The second wall portion 24b extends from the second side 23b of the planar portion 23 in a direction away from the fourth end portion 62 of the housing 60, and has a second inner side surface 24b1 and a second outer side surface 24b2 opposite to the second inner side surface 24b1. The third wall portion 24c extends from the third side 23c of the planar portion 23 in a direction away from the fourth end portion 62 of the housing 60, and has a third inner side surface 24c1 and a third outer side surface 24c2 opposite to the third inner side surface 24c1. The fourth wall portion 24d extends from the fourth side 23d of the planar portion 23 in a direction away from the fourth end portion 62 of the housing 60, and has a fourth inner side surface 24d1 and a fourth outer side surface 24d2 opposite to the fourth inner side surface 24d1. The first wall portion 24a includes a first locking portion 24a3 having an inner side surface and a back surface at a central portion of the first outer side surface 24a2. The second wall portion 24b includes a second locking portion 24b3 having an inner side surface and a back surface at a central portion of the second outer side surface 24b2. The third wall portion 24c includes a third locking portion 24c3 having an inner side surface and a back surface at a central portion of the third outer side surface 24c2. The fourth wall portion 24d includes a fourth locking portion 24d3 having an inner side surface and a back surface at a central portion of the fourth outer side surface 24d2. The first outer side surface 24a2 can be regarded as including the back surface of the first locking portion 24a3. The second outer side surface 24b2 can be regarded as including the back surface of the second locking portion 24b3. The third outer side surface 24c2 can be regarded as including the back surface of the third locking portion 24c3. The fourth outer side surface 24d2 can be regarded as including the back surface of the fourth locking portion 24d3.

The first surface portion 25a is connected to the first wall portion 24a and extends away from the optical axis L. The second surface portion 25b is connected to the second wall portion 24b and extends away from the optical axis L. The third surface portion 25c is connected to the third wall portion 24c and extends away from the optical axis L. The fourth surface portion 25d is connected to the fourth wall portion 24d and extends away from the optical axis L. At least a part of each of the first surface portion 25a, the second surface portion 25b, the third surface portion 25c, and the fourth surface portion 25d includes the second portion 22.

Accordingly, the lens barrel 30 can be disposed in a space surrounded by the ring member 20 and the four wall portions, and the four surface portions can be used for connection to the housing 60, so that assembly can be easily performed.

At least a part of the first end surface 34a of the flange portion 34 of the lens barrel 30 is in contact with the first inner side surface 24al of the first wall portion 24a of the ring member 20. At least a part of the second end surface 34b of the flange portion 34 of the lens barrel 30 is in contact with the second inner side surface 24b1 of the second wall portion 24b of the ring member 20. At least a part of the third end surface 34c of the flange portion 34 of the lens barrel 30 is in contact with the third inner side surface 24cl of the third wall portion 24c of the ring member 20. At least a part of the fourth end surface 34d of the flange portion 34 of the lens barrel 30 is in contact with the fourth inner side surface 24d1 of the fourth wall portion 24d of the ring member 20. Accordingly, the lens barrel 30 can be stably disposed in the space surrounded by the ring member 20 and the four wall portions.

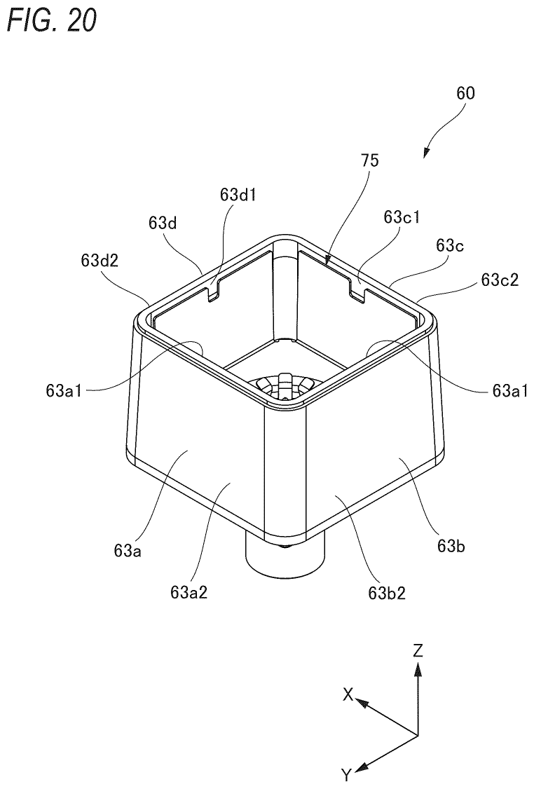

As illustrated in FIG. 20 to be described later, the housing 60 includes a first side wall portion 63a, a second side wall portion 63b, a third side wall portion 63c, and a fourth side wall portion 63d. The first side wall portion 63a has a first inner wall surface 63al and a first outer wall surface 63a2. The second side wall portion 63b has a second inner wall surface 63b1 and a second outer wall surface 63b2. The third side wall portion 63c has a third inner wall surface 63c1 and a third outer wall surface 63c2. The fourth side wall portion 63d has a fourth inner wall surface 63d1 and a fourth outer wall surface 63d2.

Then, the back surface of the first locking portion 24a3, which is at least a part of the first outer side surface 24a2 of the first wall portion 24a of the ring member 20, is in contact with at least a part of the first inner wall surface 63al of the first side wall portion 63a of the housing 60. The back surface of the second locking portion 24b3, which is at least a part of the second outer side surface 24b2 of the second wall portion 24b of the ring member 20, is in contact with at least a part of the second inner wall surface 63b1 of the second side wall portion 63b of the housing 60. The back surface of the third locking portion 24c3, which is at least a part of the third outer side surface 24c2 of the third wall portion 24c of the ring member 20, is in contact with at least a part of the third inner wall surface 63cl of the third side wall portion 63c of the housing 60. The back surface of the fourth locking portion 24d3, which is at least a part of the fourth outer side surface 24d2 of the fourth wall portion 24d of the ring member 20, is in contact with at least a part of the fourth inner wall surface 63d1 of the fourth side wall portion 63d of the housing 60. Accordingly, the ring member 20 can be stably disposed while being in contact with the four inner wall surfaces of the housing 60.

Further, the ring member 20 includes, in the planar portion 23, a third surface 23e, a fourth surface 23f opposite to the third surface 23e, and at least one projection portion 26 protruding from the fourth surface 23f of the planar portion 23 toward the first surface 40a of the circuit board 40. Accordingly, the ring member 20 and the circuit board 40 can be connected, and the circuit board 40 can be stably disposed inside the housing 60.

The at least one projection portion 26 of the ring member 20 includes a first projection portion 26a, a second projection portion 26b, a third projection portion 26c, and a fourth projection portion 26d, each of which protrudes from the fourth surface 23f of the planar portion 23 of the ring member 20 toward the first surface 40a of the circuit board 40. Accordingly, the ring member 20 and the circuit board 40 can be stably connected. The first projection portion 26a, the second projection portion 26b, the third projection portion 26c, and the fourth projection portion 26d are formed near corner portions of the planar portion 23.

Further, the ring member 20 further includes a first central portion C1 in which a first hole 23g is formed in the planar portion 23, and the at least a part of the second end portion 32 of the lens barrel 30 passes through the first hole 23g of the first central portion C1 of the planar portion 23 of the ring member 20. Accordingly, the light that has passed through the lens barrel 30 can pass through the first hole 23g of the planar portion 23 of the ring member 20.

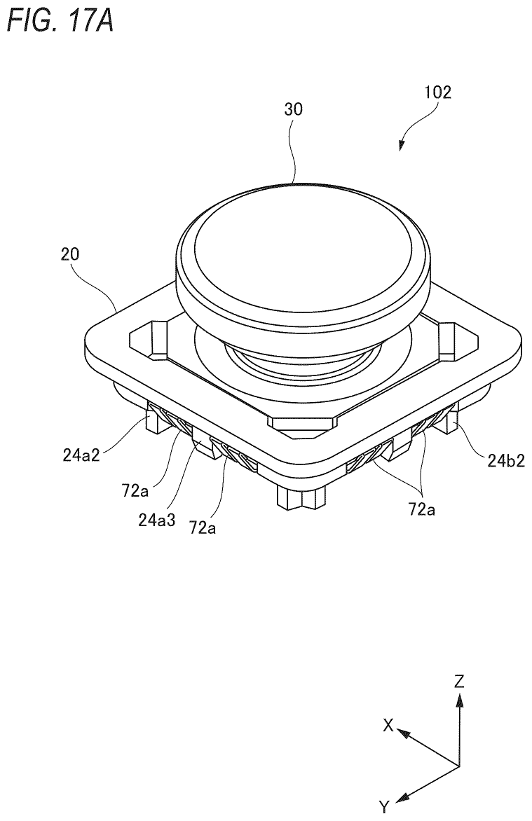

The vehicular camera 100 according to the embodiment further includes a metallic first shield 70 that is attached to the ring member 20 and faces the first surface 40a of the circuit board 40 and the fourth surface 23f of the planar portion 23 of the ring member 20. As illustrated in FIG. 16 to be described later, the first shield 70 has a second central portion C2 in which a second hole 70a corresponding to the first hole 23g of the planar portion 23 of the ring member 20 is formed. Accordingly, the light that has passed through the ring member 20 can pass through the second hole 70a of the first shield.

The first shield 70 includes a shield planar portion 71. A third hole 71a through which the first projection portion 26a of the ring member 20 penetrates, a fourth hole 71b through which the second projection portion 26b of the ring member 20 penetrates, a fifth hole 71c through which the third projection portion 26c of the ring member 20 penetrates, and a sixth hole 71d through which the fourth projection portion 26d of the ring member 20 penetrates are formed in the shield planar portion 71 of the first shield 70. Accordingly, the four projection portions of the ring member 20 can penetrate the four holes of the shield planar portion 71 of the first shield 70 and reach the first surface 40a of the circuit board 40.

The first projection portion 26a, the second projection portion 26b, the third projection portion 26c, and the fourth projection portion 26d of the ring member 20 are connected to the first surface 40a of the circuit board 40 via an adhesive X. Accordingly, the ring member 20 and the circuit board 40 can be firmly connected.

The vehicular camera 100 according to the embodiment further includes a metallic second shield 75 disposed to surround at least the imaging element 50 and the circuit board 40 inside the housing 60. The first shield 70 is electrically connected to the second shield 75. Accordingly, the first shield 70 and the second shield 75 cooperate to improve shield performance for blocking noise inside the housing 60.

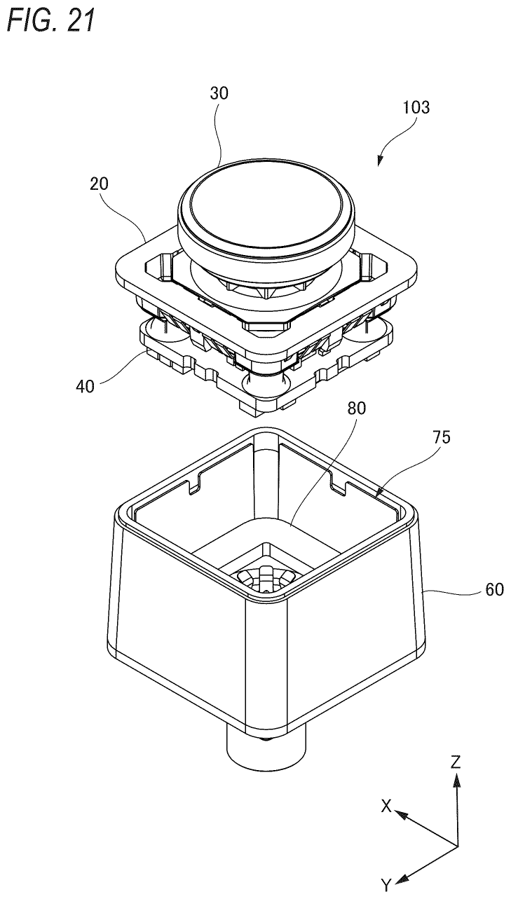

As illustrated in FIG. 21 to be described later, the vehicular camera 100 according to the embodiment further includes a resin member 80 disposed at least between the second surface 40b of the circuit board 40 and the fourth end portion 62 of the housing 60 inside the housing 60. Accordingly, heat generated from the circuit board 40 can be dissipated by the resin member 80. The resin member 80 can also impart the shield performance for blocking noise.

The vehicular camera 100 according to the embodiment further includes a connector connection portion 45 disposed on the second surface 40b of the circuit board 40 and a connector 90 (see FIG. 10). The connector 90 includes a first connector end portion 91 and a second connector end portion 92 disposed opposite to the first connector end portion 91, and is disposed at the fourth end portion 62 of the housing 60. The first connector end portion 91 of the connector 90 is electrically connected to the connector connection portion 45 of the second surface 40b of the circuit board 40. Accordingly, electric power from the outside can be supplied to the circuit board 40.

When the vehicular camera 100 is disposed in the vehicle V, the second connector end portion 82 of the connector 90 is electrically connected to a wire of the vehicle V. Examples of the connector 90 include a coaxial connector, a shielded twisted quad (STQ) connector, and a shielded twisted pair (STP) connector. The connector connection portion 45 is implemented by, for example, a floating connector. Accordingly, electric power from the vehicle V can be supplied to the circuit board 40 via the wire. When the connector 90 is the coaxial connector, a high-frequency signal can be supplied to the circuit board 40 in addition to the electric power.

In the vehicular camera 100 according to the embodiment, in the first welded portion W1, the first portion 21 of the ring member 20 and at least a part of the third end portion 61 of the housing 60 are welded by laser over the entire periphery around the optical axis L, the first portion 21 being disposed over the entire periphery around the optical axis L. Further, in the second welded portion W2, the second portion 22 of the ring member 20 and the at least a part of the second end portion 32 of the lens barrel 30 are welded by laser over the entire periphery around the optical axis L, the second portion 22 being disposed over the entire periphery around the optical axis L. Accordingly, the welding can be easily and firmly performed.

The lens barrel 30 may be formed of a first resin having the first light absorptance. The housing 60 may be formed of a second resin having the second light absorptance. The ring member 20 may be formed of a third resin having the third light absorptance. Accordingly, the welding by the laser can be efficiently performed. Details of the laser welding will be described in the following assembly step.

The assembly step of the vehicular camera 100 will be described with reference to FIGS. 13 to 22. FIG. 13 is a perspective view of the lens barrel 30 viewed from a second end portion 32 side. FIG. 14A is a perspective view of the ring member 20 as viewed from a third surface 23e side of the planar portion 23, and FIG. 14B is a perspective view of the ring member 20 as viewed from a fourth surface 23f side of the planar portion 23.

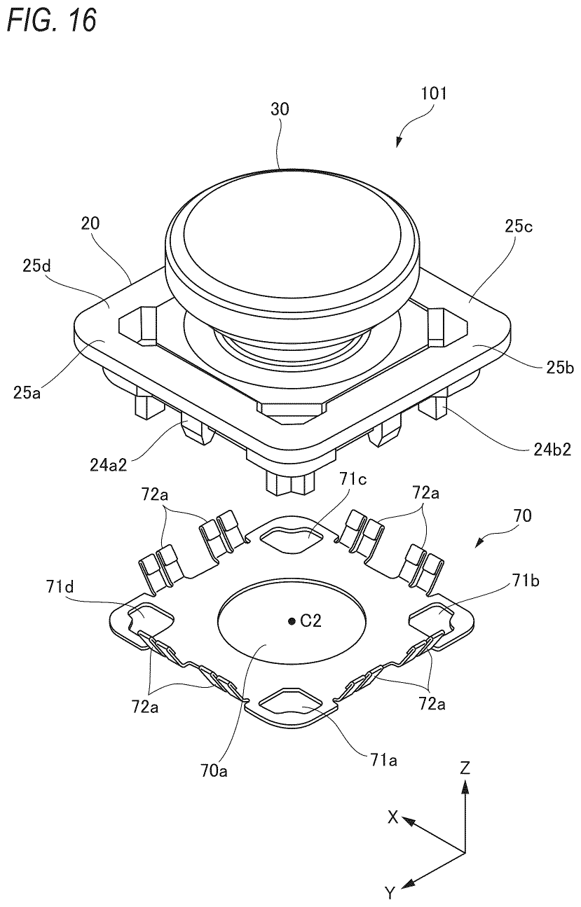

FIG. 15 is a perspective view illustrating a state in which the lens barrel 30 and the ring member 20 are welded by the laser welding to assemble a first assembly 101. First, the ring member 20 in the posture illustrated in FIG. 14B is placed on the second end portion 32 of the lens barrel 30 in the posture illustrated in FIG. 13. At this time, at least a part of the second end portion 32 of the lens barrel 30 passes through the first hole 23g of the first central portion C1 of the planar portion 23 of the ring member 20. Further, as illustrated in FIG. 16, the at least a part of the first end surface 34a of the flange portion 34 of the lens barrel 30 is in contact with the first inner side surface 24al of the first wall portion 24a of the ring member 20. The at least a part of the second end surface 34b of the flange portion 34 of the lens barrel 30 is in contact with the second inner side surface 24b1 of the second wall portion 24b of the ring member 20. The at least a part of the third end surface 34c of the flange portion 34 of the lens barrel 30 is in contact with the third inner side surface 24cl of the third wall portion 24c of the ring member 20. The at least a part of the fourth end surface 34d of the flange portion 34 of the lens barrel 30 is in contact with the fourth inner side surface 24d1 of the fourth wall portion 24d of the ring member 20.

After the placement, the laser irradiation apparatus irradiates a laser in a direction from top to bottom in FIG. 15 as indicated by an arrow, so that the at least a part of the second end portion 32 of the lens barrel 30 and the second portion 22 of the ring member 20 are welded at the second welded portion W2, and the lens barrel 30 and the ring member 20 are integrated to complete the first assembly 101. In the present embodiment, the second portion 22 of the ring member 20 is welded to the lens barrel protruding top portion 32cl of the lens barrel protruding portion 32c of the second end portion 32 of the lens barrel 30.

The laser irradiation is performed from a side of the outer side surface 30b where the part 30b1 the farthest from the optical axis L is not present. Accordingly, even if the diameter of the lens 33 increases and the diameter of the lens barrel 30, particularly the diameter thereof at the part 30b1 of the outer side surface 30b increases due to the requirement for the high imaging performance, the second welded portion W2 can be formed inside the part 30b1 of the outer side surface 30b in the radial direction. Therefore, it is possible to prevent the size of the vehicular camera 100, particularly the size in the radial direction, from increasing outward.

Further, even if the position of the laser irradiation is radially inside the part 30b1 of the outer side surface 30b, the laser welding can be smoothly performed without being hindered by the part 30b1, and the second welded portion W2 can be formed. Since no optical member that refracts the laser is required in order to avoid the part 30b1 of the outer side surface 30b, there is no possibility that the accuracy of the irradiation position is reduced.

The third light absorptance of the ring member 20 is smaller than the first light absorptance of the second end portion 32 of the lens barrel 30. Therefore, since the laser in FIG. 15 is hardly absorbed by the ring member 20 while passing through the ring member 20, and is greatly absorbed by the second end portion 32 of the lens barrel 30, the laser welding can be efficiently performed.

FIG. 16 is a perspective view of the first assembly 101 and the first shield 70. The posture of the first assembly 101 of FIG. 16 is a posture in which the posture illustrated in FIG. 15 is turned upside down, and the first shield 70 is attached to the first assembly 101 from the fourth surface 23f side of the ring member 20 of the first assembly 101.

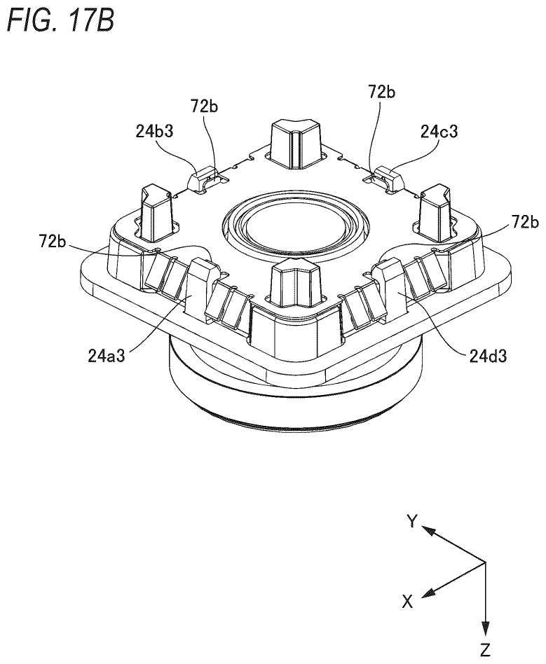

FIG. 17A is a top perspective view of a second assembly 102 in which the first assembly 101 and the first shield 70 are assembled. FIG. 17B is a bottom perspective view of the second assembly 102 in which the first assembly 101 and the first shield 70 are assembled. A claw portion 72a (first claw portion) and a claw portion 72b (second claw portion) having flexibility are provided on each of four sides of the shield planar portion 71 of the first shield 70. The claw portion 72b of the first shield 70 is engaged with the inner side surface of the first locking portion 24a3, the inner side surface of the second locking portion 24b3, the inner side surface of the third locking portion 24c3, and the inner side surface of the fourth locking portion 24d3 of the ring member 20 by elastic force, so that the first assembly 101 and the first shield 70 are integrated to complete the second assembly 102.

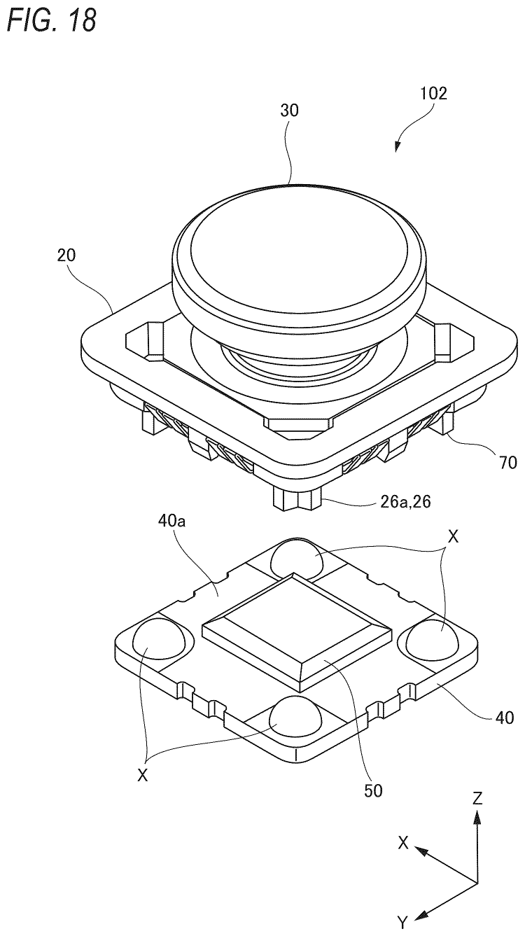

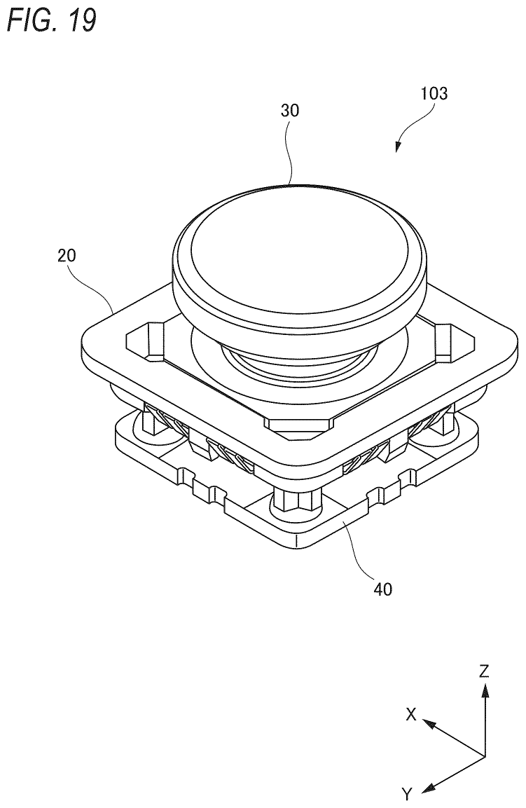

FIG. 18 is a perspective view of the circuit board 40 with the second assembly 102 and the imaging element 50. The imaging element 50 and the circuit board 40 are assembled in advance. FIG. 19 is a perspective view of a third assembly 103 in which the second assembly 102 and the circuit board 40 are assembled. By connecting the respective tips of the first projection portion 26a, the second projection portion 26b, the third projection portion 26c, and the fourth projection portion 26d of the ring member 20 to the first surface 40a of the circuit board 40 via the adhesive X, the second assembly 102 and the circuit board 40 are integrated to complete the third assembly 103.

FIG. 20 is a perspective view of the housing 60 accommodating the second shield 75. The second shield 75 is attached to the housing 60 separately from the assembly of the third assembly 103. The second shield 75 is in contact with at least a part of the first inner wall surface 63al of the first side wall portion 63a of the housing 60, at least a part of the second inner wall surface 63b1 of the second side wall portion 63b, at least a part of the third inner wall surface 63cl of the third side wall portion 63c, and at least a part of the fourth inner wall surface 63d1 of the fourth side wall portion 63d.

FIG. 21 is a perspective view of the third assembly 103 and the housing 60. After the resin member 80 is disposed inside the housing 60, the third assembly 103 and the housing 60 are welded.

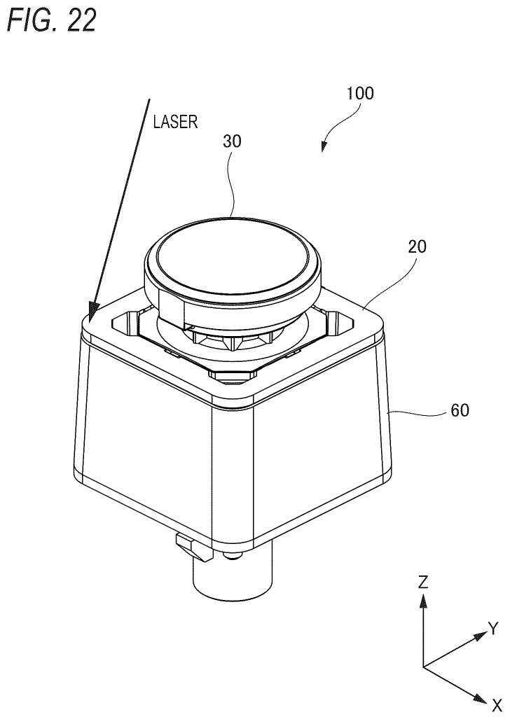

FIG. 22 is a perspective view illustrating a state in which the third assembly 103 and the housing 60 are welded by the laser welding to assemble the vehicular camera 100. When the laser irradiation apparatus irradiates the laser in the direction from top to bottom in FIG. 22 as indicated by the arrow, the first portion 21 of the ring member 20 and the at least a part of the third end portion 61 of the housing 60 are welded at the first welded portion W1, and the vehicular camera 100 is completed. In the present embodiment, the first portion 21 of the ring member 20 is welded to the housing protruding top portion 61cl of the housing protruding portion 61c of the third end portion 61 of the housing 60.

In this assembly step, since the laser welding illustrated in FIG. 22 is performed after the posture of the first assembly 101 completed by the laser welding illustrated in FIG. 15 is turned upside down, that is, turned upside down in the Z direction, the laser irradiation direction in FIG. 15 and the laser irradiation direction in FIG. 22 can be made the same. That is, a series of assembly steps can be performed only by changing the posture of the first assembly 101 without changing the laser irradiation direction of the laser irradiation apparatus. Although changing the laser irradiation direction of the laser irradiation apparatus is complicated, changing the posture of the first assembly 101 is relatively easy.

Moreover, in FIG. 15, it is possible to perform welding at the second welded portion W2 inside the part 30b1 while avoiding the part 30b1 of the outer side surface 30b of the lens barrel 30, and to perform welding at the second welded portion W2 outside the part 30b1 as illustrated in FIG. 22 from the same direction as in FIG. 15. As a result, it is possible to perform welding at the two welded portions that are the first welded portion W1 and the second welded portion W2 from the same direction, and it is possible to prevent the assembly step from becoming complicated while preventing an increase in the size of the vehicular camera 100.

The third light absorptance of the ring member 20 is smaller than the second light absorptance of the third end portion 61 of the housing 60. Therefore, since the laser in FIG. 22 is less likely to be absorbed by the ring member 20 while passing through the ring member 20, and is significantly absorbed by the third end portion 61 of the housing 60, the laser welding can be efficiently performed.

As a result, the back surface of the first locking portion 24a3, which is the at least a part of the first outer side surface 24a2 of the first wall portion 24a of the ring member 20, is in contact with the at least a part of the first inner wall surface 63al of the first side wall portion 63a of the housing 60. The back surface of the second locking portion 24b3, which is the at least a part of the second outer side surface 24b2 of the second wall portion 24b of the ring member 20, is in contact with the at least a part of the second inner wall surface 63b1 of the second side wall portion 63b of the housing 60. The back surface of the third locking portion 24c3, which is the at least a part of the third outer side surface 24c2 of the third wall portion 24c of the ring member 20, is in contact with the at least a part of the third inner wall surface 63cl of the third side wall portion 63c of the housing 60. The back surface of the fourth locking portion 24d3, which is the at least a part of the fourth outer side surface 24d2 of the fourth wall portion 24d of the ring member 20, is in contact with the at least a part of the fourth inner wall surface 63d1 of the fourth side wall portion 63d of the housing 60.

As illustrated in FIG. 17B, the claw portion 72b of the first shield 70 is engaged with the inner side surface of the first locking portion 24a3, the inner side surface of the second locking portion 24b3, the inner side surface of the third locking portion 24c3, and the inner side surface of the fourth locking portion 24d3 of the ring member 20. Further, the first shield 70 is electrically connected to the second shield 75 via the claw portion 72a.

As described above, at least the following matters are described in the present disclosure. Components corresponding to those in the embodiment are illustrated in parentheses, but the present disclosure is not limited thereto.

(1) A vehicular camera (vehicular camera 100) including:
a lens barrel (lens barrel 30) including an inner side surface (inner side surface 30a) and an outer side surface (outer side surface 30b), having a first tubular shape along an optical axis (optical axis L), and including a first end portion (first end portion 31), a second end portion (second end portion 32) opposite to the first end portion, and at least one lens (lens 33) disposed along the optical axis;
an imaging element (imaging element 50) disposed on the optical axis and is closer to the second end portion of the lens barrel than to the first end portion of the first tubular shape of the lens barrel;
a circuit board (circuit board 40) including a first surface (first surface 40a) and a second surface (second surface 40b) opposite to the first surface, the imaging element being disposed on the first surface;
a housing (housing 60) enclosing at least the imaging element and the circuit board, having a second tubular shape along the optical axis, and including a third end portion (third end portion 61) and a fourth end portion (fourth end portion 62) that is farther than the third end portion with respect to the first end portion of the lens barrel and is disposed opposite to the third end portion;
a ring member (ring member 20) facing at least a part of the second end portion of the lens barrel and at least a part of the third end portion of the housing, and accommodating at least the imaging element and the circuit board together with the housing;
a first welded portion (first welded portion W1) in which a first portion (first portion 21) of the ring member and the at least a part of the third end portion of the housing are welded over an entire periphery around the optical axis, the first portion being disposed over the entire periphery around the optical axis; and
a second welded portion (second welded portion W2) in which a second portion (second portion 22) of the ring member and the at least a part of the second end portion of the lens barrel are welded over the entire periphery around the optical axis, the second portion being disposed over the entire periphery around the optical axis, in which
the second end portion of the lens barrel has a first light absorptance,
the third end portion of the housing has a second light absorptance,
the ring member has a third light absorptance,
the third light absorptance is smaller than the first light absorptance and smaller than the second light absorptance,
the first portion of the ring member is disposed closer to the third end portion of the housing than to the fourth end portion of the housing,
the second portion of the ring member is disposed closer to the second end portion of the lens barrel than to the fourth end portion of the housing,
the first welded portion is located outside a part (a part 30b1) of the outer side surface of the lens barrel with respect to the optical axis, and
the second welded portion is located inside the part of the outer side surface of the lens barrel with respect to the optical axis.

According to the vehicular camera of the present disclosure, the first portion of the ring member and the at least a part of the third end portion of the housing are welded at the first welded portion, and the second portion of the ring member and the at least a part of the second end portion of the lens barrel are welded at the second welded portion. The first welded portion is located outside the part of the outer side surface of the lens barrel with respect to the optical axis, and the second welded portion is located inside the part of the outer side surface of the lens barrel with respect to the optical axis. Accordingly, even if the diameters of the lens and the lens barrel increase in order to improve the imaging performance, it is possible to perform welding at the first welded portion and the second welded portion from the same direction, and it is possible to prevent the assembly step from becoming complicated while preventing an increase in the size of the vehicular camera.

(2) The vehicular camera according to (1), in which
the second welded portion is closer to the fourth end portion of the housing than the first welded portion in a direction along the optical axis.

Accordingly, the welding of the ring member and the lens barrel can be performed at a position different from the welding of the ring member and the housing in the direction along the optical axis.

(3) The vehicular camera according to (1), in which
the part of the outer side surface of the lens barrel is the farthest from the optical axis on the outer side surface.

Accordingly, the first welded portion can be reliably disposed outside the outer side surface of the lens barrel.

(4) The vehicular camera according to (1), in which
the second end portion of the lens barrel includes
   a first region (first region 32a) disposed over the entire periphery around the optical axis,
   a second region (second region 32b) disposed outside the first region with respect to the optical axis over the entire periphery around the optical axis, and
   a lens barrel protruding portion (lens barrel protruding portion 32c) protruding from the second region in a direction away from the first end portion of the lens barrel and disposed over the entire periphery around the optical axis,
the lens barrel protruding portion includes
   a lens barrel protruding top portion (lens barrel protruding top portion 32c1) that is a top portion,
   a first lens barrel protruding side surface (first lens barrel protruding side surface 32c2) connected to the lens barrel protruding top portion and the first region and disposed over the entire periphery around the optical axis, and
   a second lens barrel protruding side surface (second lens barrel protruding side surface 32c3) connected to at least the lens barrel protruding top portion and disposed opposite to the first lens barrel protruding side surface over the entire periphery around the optical axis,
the third end portion of the housing includes
   a third region (third region 61a) disposed over the entire periphery around the optical axis,
   a fourth region (fourth region 61b) disposed outside the third region with respect to the optical axis over the entire periphery around the optical axis, and
   a housing protruding portion (housing protruding portion 61c) protruding from the third region in a direction away from the third end portion of the housing and disposed over the entire periphery around the optical axis,
the housing protruding portion includes
   a housing protruding top portion (housing protruding top portion 61c1) that is a top portion,
   a first housing protruding side surface (first housing protruding side surface 61c2) connected to at least the housing protruding top portion and disposed over the entire periphery around the optical axis, and
   a second housing protruding side surface (second housing protruding side surface 61c3) connected to the housing protruding top portion and the fourth region of the third end portion of the housing, and disposed opposite to the first housing protruding side surface around the entire periphery around the optical axis,
the at least a part of the third end portion of the housing is the housing protruding top portion of the housing protruding portion,
the at least a part of the second end portion of the lens barrel is the lens barrel protruding top portion of the lens barrel protruding portion,
in the first welded portion, the first portion of the ring member and the housing protruding top portion of the housing protruding portion of the third end portion of the housing are welded over the entire periphery around the optical axis, the first portion being disposed over the entire periphery around the optical axis, and
in the second welded portion, the second portion of the ring member and the lens barrel protruding top portion of the lens barrel protruding portion of the second end portion of the lens barrel are welded over the entire periphery around the optical axis, the second portion being disposed over the entire periphery around the optical axis.

Accordingly, the first portion of the ring member and the housing protruding top portion of the housing protruding portion of the third end portion of the housing are welded at the first welded portion, and the second portion of the ring member and the lens barrel protruding top portion of the lens barrel protruding portion of the second end portion of the lens barrel are welded at the second welded portion. Accordingly, the two welded portions are reliably formed, and the ring member and the housing, and the ring member and the lens barrel can be firmly connected.

(5) The vehicular camera according to (1), in which
the lens barrel further has a flange portion (flange portion 34) disposed on an outside of the first tubular shape to extend outward with respect to the optical axis over the entire periphery around the optical axis, and
the flange portion has a first shape including a first end surface (first end surface 34a) corresponding to a first side, a second end surface (second end surface 34b) corresponding to a second side, a third end surface (third end surface 34c) corresponding to a third side, and a fourth end surface (fourth end surface 34d) corresponding to a fourth side in a plan view of the flange portion.

Accordingly, since the lens barrel has the flange portion, the flange portion can be used for connection with the ring member.

(6) The vehicular camera according to (5), in which
the ring member further has
   a planar portion (planar portion 23) having a first side (first side 23a), a second side (second side 23b) connected to the first side, a third side (third side 23c) connected to the second side, and a fourth side (fourth side 23d) connected to the third side,
   a first wall portion (first wall portion 24a) extending from the first side of the planar portion in a direction away from the fourth end portion of the housing and having a first inner side surface (first inner side surface 24a1) and a first outer side surface (first outer side surface 24a2) opposite to the first inner side surface,
   a second wall portion (second wall portion 24b) extending from the second side of the planar portion in the direction away from the fourth end portion of the housing and having a second inner side surface (second inner side surface 24b1) and a second outer side surface (second outer side surface 24b2) opposite to the second inner side surface,
   a third wall portion (third wall portion 24c) extending from the third side of the planar portion in the direction away from the fourth end portion of the housing and having a third inner side surface (third inner side surface 24cl) and a third outer side surface (third outer side surface 24c2) opposite to the third inner side surface,
   a fourth wall portion (fourth wall portion 24d) extending from the fourth side of the planar portion in the direction away from the fourth end portion of the housing and having a fourth inner side surface (fourth inner side surface 24d1) and a fourth outer side surface (fourth outer side surface 24d2) opposite to the fourth inner side surface,
   a first surface portion (first surface portion 25a) connected to the first wall portion and extending away from the optical axis,
   a second surface portion (second surface portion 25b) connected to the second wall portion and extending away from the optical axis,
   a third surface portion (third surface portion 25c) connected to the third wall portion and extending away from the optical axis, and
   a fourth surface portion (fourth surface portion 25d) connected to the fourth wall portion and extending away from the optical axis.

Accordingly, the lens barrel can be disposed in a space surrounded by the ring member and the four wall portions, and the four surface portions can be used for connection to the housing, so that assembly can be easily performed.

(7) The vehicular camera according to (6), in which
at least a part of the first end surface of the flange portion of the lens barrel is in contact with the first inner side surface of the first wall portion of the ring member,
at least a part of the second end surface of the flange portion of the lens barrel is in contact with the second inner side surface of the second wall portion of the ring member,
at least a part of the third end surface of the flange portion of the lens barrel is in contact with the third inner side surface of the third wall portion of the ring member, and
at least a part of the fourth end surface of the flange portion of the lens barrel is in contact with the fourth inner side surface of the fourth wall portion of the ring member.

Accordingly, the lens barrel can be stably disposed in the space surrounded by the ring member and the four wall portions.

(8) The vehicular camera according to (6), in which
the housing further has a first side wall portion (first side wall portion 63a) having a first inner wall surface (first inner wall surface 63a1) and a first outer wall surface (first outer wall surface 63a2), a second side wall portion (second side wall portion 63b) having a second inner wall surface (second inner wall surface 63b1) and a second outer wall surface (second outer wall surface 63b2), a third side wall portion (third side wall portion 63c) having a third inner wall surface (third inner wall surface 63c1) and a third outer wall surface (third outer wall surface 63c2), and a fourth side wall portion (fourth side wall portion 63d) having a fourth inner wall surface (fourth inner wall surface 63d1) and a fourth outer wall surface (fourth outer wall surface 63d2),
at least a part of the first outer side surface of the first wall portion of the ring member (a back surface of a first locking portion 24a3) is in contact with at least a part of the first inner wall surface of the first side wall portion of the housing,
at least a part of the second outer side surface of the second wall portion of the ring member (a back surface of a second locking portion 24b3) is in contact with at least a part of the second inner wall surface of the second side wall portion of the housing,
at least a part of the third outer side surface of the third wall portion of the ring member (a back surface of a third locking portion 24c3) is in contact with at least a part of the third inner wall surface of the third side wall portion of the housing, and
at least a part of the fourth outer side surface of the fourth wall portion of the ring member (a back surface of a fourth locking portion 24d3) is in contact with at least a part of the fourth inner wall surface of the fourth side wall portion of the housing.

Accordingly, the ring member can be stably disposed while being in contact with the four inner wall surfaces of the housing.

(9) The vehicular camera according to (6), in which
the ring member has
   a third surface (third surface 23e) and a fourth surface (fourth surface 23f) opposite to the third surface in the planar portion, and
   at least one projection portion (projection portion 26) protruding from the fourth surface of the planar portion toward the first surface of the circuit board.

Accordingly, the ring member and the circuit board can be connected, and the circuit board can be stably disposed inside the housing.

(10) The vehicular camera according to (9), in which
at least one projection portion of the ring member includes
   a first projection portion (first projection portion 26a) protruding from the fourth surface of the planar portion of the ring member toward the first surface of the circuit board,
   a second projection portion (second projection portion 26b) protruding from the fourth surface of the planar portion of the ring member toward the first surface of the circuit board,
   a third projection portion (third projection portion 26c) protruding from the fourth surface of the planar portion of the ring member toward the first surface of the circuit board, and
   a fourth projection portion (fourth projection portion 26d) protruding from the fourth surface of the planar portion of the ring member toward the first surface of the circuit board.

Accordingly, the ring member and the circuit board can be stably connected.

(11) The vehicular camera according to (10), in which
the ring member further has a first central portion (first central portion C1) in which a first hole (first hole 23g) is formed in the planar portion, and
at least a part of the second end portion of the lens barrel passes through the first hole of the first central portion of the planar portion of the ring member.

Accordingly, the light that has passed through the lens barrel can pass through the first hole of the planar portion of the ring member.

(12) The vehicular camera according to (11), further including:
a metallic first shield (first shield 70) attached to the ring member and facing the first surface of the circuit board and the fourth surface of the planar portion of the ring member, in which
the first shield has a second central portion (second central portion C2) in which a second hole (second hole 70a) corresponding to the first hole of the planar portion of the ring member is formed.

Accordingly, the light that has passed through the ring member can pass through the second hole of the first shield.

(13) The vehicular camera according to (12), in which
the first shield has a shield planar portion (shield planar portion 71), and
a third hole (third hole 71a) through which the first projection portion of the ring member penetrates, a fourth hole (fourth hole 71b) through which the second projection portion of the ring member penetrates, a fifth hole (fifth hole 71c) through which the third projection portion of the ring member penetrates, and a sixth hole (sixth hole 71d) through which the fourth projection portion of the ring member penetrates are formed in the shield planar portion of the first shield.

Accordingly, the four projection portions of the ring member can penetrate the four holes of the shield planar portion of the first shield and reach the first surface of the circuit board.

(14) The vehicular camera according to (13), in which
the first projection portion, the second projection portion, the third projection portion, and the fourth projection portion of the ring member are connected to the first surface of the circuit board via an adhesive (adhesive X).

Accordingly, the ring member and the circuit board can be firmly connected.

(15) The vehicular camera according to (12), further including:
a metallic second shield (second shield 75) disposed to surround at least the imaging element and the circuit board inside the housing, in which
the first shield is electrically connected to the second shield.

Accordingly, the first shield and the second shield can cooperate to improve the shield performance for blocking noise inside the housing.

(16) The vehicular camera according to (1), further including:
a resin member (resin member 80) disposed at least between the second surface of the circuit board and the fourth end portion of the housing inside the housing.

Accordingly, heat generated from the circuit board can be dissipated by the resin member.

(17) The vehicular camera according to (1), further including:
a connector connection portion (connector connection portion 45) disposed on the second surface of the circuit board; and
a connector (connector 90) that has a first connector end portion (first connector end portion 91) and a second connector end portion (second connector end portion 92) disposed opposite to the first connector end portion, and is disposed on the fourth end portion of the housing, in which
the first connector end portion of the connector is electrically connected to the connector connection portion on the second surface of the circuit board.

Accordingly, electric power from the outside can be supplied to the circuit board.

(18) The vehicular camera according to (17), in which
the connector is a coaxial connector.

Accordingly, a high-frequency signal can be supplied to the circuit board in addition to electric power.

(19) The vehicular camera according to (1), in which
in the first welded portion, the first portion of the ring member and the at least a part of the third end portion of the housing are welded by a laser over the entire periphery around the optical axis, the first portion being disposed over the entire periphery around the optical axis, and
in the second welded portion, the second portion of the ring member and the at least a part of the second end portion of the lens barrel are welded by a laser over the entire periphery around the optical axis, the second portion being disposed over the entire periphery around the optical axis.

Accordingly, the welding can be easily and firmly performed.

(20) The vehicular camera according to (19), in which
the lens barrel is formed of a first resin having a first light absorptance,
the housing is formed of a second resin having a second light absorptance, and
the ring member is formed of a third resin having a third light absorptance.

Accordingly, the welding by the laser can be efficiently performed.

### INDUSTRIAL APPLICABILITY

The present disclosure is useful as a vehicular camera that can be easily assembled while preventing an increase in size.

### CROSS-REFERENCE TO RELATED APPLICATIONS

This application is based on and claims priority under 35 USC 119 from Japanese Patent Application No. 2024-095165 filed on Jun. 12, 2024, the contents of which are incorporated herein by reference.

What is claimed is:

1. A vehicular camera comprising:
a lens barrel including an inner side surface and an outer side surface, having a first tubular shape along an optical axis, and including a first end portion, a second end portion opposite to the first end portion, and at least one lens disposed along the optical axis;
an imaging element disposed on the optical axis and is placed closer to the second end portion of the lens barrel than to the first end portion of the first tubular shape of the lens barrel;
a circuit board including a first surface and a second surface opposite to the first surface, the imaging element being disposed on the first surface;
a housing enclosing at least the imaging element and the circuit board, having a second tubular shape along the optical axis, and including a third end portion and a fourth end portion that is farther than the third end portion with respect to the first end portion of the lens barrel and is disposed opposite to the third end portion;
a ring member facing at least a part of the second end portion of the lens barrel and at least a part of the third end portion of the housing, and accommodating at least the imaging element and the circuit board together with the housing;
a first welded portion in which a first portion of the ring member and the at least a part of the third end portion of the housing are welded over an entire periphery around the optical axis, the first portion of the ring member being disposed over the entire periphery around the optical axis; and
a second welded portion in which a second portion of the ring member and the at least a part of the second end portion of the lens barrel are welded over the entire periphery around the optical axis, the second portion of the ring member being disposed over the entire periphery around the optical axis, wherein
the second end portion of the lens barrel has a first light absorptance,
the third end portion of the housing has a second light absorptance,
the ring member has a third light absorptance,
the third light absorptance is smaller than the first light absorptance and smaller than the second light absorptance,
the first portion of the ring member is disposed closer to the third end portion of the housing than to the fourth end portion of the housing,
the second portion of the ring member is disposed closer to the second end portion of the lens barrel than to the fourth end portion of the housing,
the first welded portion is located outside a part of the outer side surface of the lens barrel with respect to the optical axis, and
the second welded portion is located inside the part of the outer side surface of the lens barrel with respect to the optical axis.

2. The vehicular camera according to claim 1, wherein
the second welded portion is closer to the fourth end portion of the housing than the first welded portion in a direction along the optical axis.

3. The vehicular camera according to claim 1, wherein
the part of the outer side surface of the lens barrel is the farthest from the optical axis on the outer side surface.

4. The vehicular camera according to claim 1, wherein
the second end portion of the lens barrel includes
a first region disposed over the entire periphery around the optical axis,
a second region disposed outside the first region with respect to the optical axis over the entire periphery around the optical axis, and
a lens barrel protruding portion protruding from the second region in a direction away from the first end portion of the lens barrel and disposed over the entire periphery around the optical axis,
the lens barrel protruding portion includes
a lens barrel protruding top portion that is a top portion,
a first lens barrel protruding side surface connected to the lens barrel protruding top portion and the first region and disposed over the entire periphery around the optical axis, and
a second lens barrel protruding side surface connected to at least the lens barrel protruding top portion and disposed opposite to the first lens barrel protruding side surface over the entire periphery around the optical axis,
the third end portion of the housing includes
a third region disposed over the entire periphery around the optical axis,
a fourth region disposed outside the third region with respect to the optical axis over the entire periphery around the optical axis, and
a housing protruding portion protruding from the third region in a direction away from the third end portion of the housing and disposed over the entire periphery around the optical axis,
the housing protruding portion includes
a housing protruding top portion that is a top portion,
a first housing protruding side surface connected to at least the housing protruding top portion and disposed over the entire periphery around the optical axis, and
a second housing protruding side surface connected to the housing protruding top portion and the fourth region of the third end portion of the housing, and disposed opposite to the first housing protruding side surface around the entire periphery around the optical axis,
the at least a part of the third end portion of the housing is the housing protruding top portion of the housing protruding portion,
the at least a part of the second end portion of the lens barrel is the lens barrel protruding top portion of the lens barrel protruding portion,
in the first welded portion, the first portion of the ring member and the housing protruding top portion of the housing protruding portion of the third end portion of the housing are welded over the entire periphery around the optical axis, and
in the second welded portion, the second portion of the ring member and the lens barrel protruding top portion of the lens barrel protruding portion of the second end portion of the lens barrel are welded over the entire periphery around the optical axis.

5. The vehicular camera according to claim 1, wherein
the lens barrel further has a flange portion disposed on an outside of the first tubular shape to extend outward with respect to the optical axis over the entire periphery around the optical axis, and
the flange portion has a first shape including a first end surface corresponding to a first side, a second end surface corresponding to a second side, a third end surface corresponding to a third side, and a fourth end surface corresponding to a fourth side in a plan view of the flange portion.

6. The vehicular camera according to claim 5, wherein
the ring member further has
a planar portion having a first side, a second side connected to the first side, a third side connected to the second side, and a fourth side connected to the third side,
a first wall portion extending from the first side of the planar portion in a direction away from the fourth end portion of the housing and having a first inner side surface and a first outer side surface opposite to the first inner side surface,
a second wall portion extending from the second side of the planar portion in the direction away from the fourth end portion of the housing and having a second inner side surface and a second outer side surface opposite to the second inner side surface,
a third wall portion extending from the third side of the planar portion in the direction away from the fourth end portion of the housing and having a third inner side surface and a third outer side surface opposite to the third inner side surface,
a fourth wall portion extending from the fourth side of the planar portion in the direction away from the fourth end portion of the housing and having a fourth inner side surface and a fourth outer side surface opposite to the fourth inner side surface,
a first surface portion connected to the first wall portion and extending away from the optical axis,
a second surface portion connected to the second wall portion and extending away from the optical axis,
a third surface portion connected to the third wall portion and extending away from the optical axis, and
a fourth surface portion connected to the fourth wall portion and extending away from the optical axis.

7. The vehicular camera according to claim 6, wherein
at least a part of the first end surface of the flange portion of the lens barrel is in contact with the first inner side surface of the first wall portion of the ring member,
at least a part of the second end surface of the flange portion of the lens barrel is in contact with the second inner side surface of the second wall portion of the ring member,
at least a part of the third end surface of the flange portion of the lens barrel is in contact with the third inner side surface of the third wall portion of the ring member, and
at least a part of the fourth end surface of the flange portion of the lens barrel is in contact with the fourth inner side surface of the fourth wall portion of the ring member.

8. The vehicular camera according to claim 6, wherein
the housing further has a first side wall portion having a first inner wall surface and a first outer wall surface, a second side wall portion having a second inner wall surface and a second outer wall surface, a third side wall portion having a third inner wall surface and a third outer wall surface, and a fourth side wall portion having a fourth inner wall surface and a fourth outer wall surface,
at least a part of the first outer side surface of the first wall portion of the ring member is in contact with at least a part of the first inner wall surface of the first side wall portion of the housing,
at least a part of the second outer side surface of the second wall portion of the ring member is in contact with at least a part of the second inner wall surface of the second side wall portion of the housing,
at least a part of the third outer side surface of the third wall portion of the ring member is in contact with at least a part of the third inner wall surface of the third side wall portion of the housing, and
at least a part of the fourth outer side surface of the fourth wall portion of the ring member is in contact with at least a part of the fourth inner wall surface of the fourth side wall portion of the housing.

9. The vehicular camera according to claim 6, wherein
the ring member has
a third surface and a fourth surface opposite to the third surface in the planar portion, and
at least one projection portion protruding from the fourth surface of the planar portion toward the first surface of the circuit board.

10. The vehicular camera according to claim 9, wherein
the at least one projection portion of the ring member includes
a first projection portion protruding from the fourth surface of the planar portion of the ring member toward the first surface of the circuit board,
a second projection portion protruding from the fourth surface of the planar portion of the ring member toward the first surface of the circuit board,
a third projection portion protruding from the fourth surface of the planar portion of the ring member toward the first surface of the circuit board, and
a fourth projection portion protruding from the fourth surface of the planar portion of the ring member toward the first surface of the circuit board.

11. The vehicular camera according to claim 10, wherein
the ring member further has a first central portion in which a first hole is formed in the planar portion, and
at least a part of the second end portion of the lens barrel passes through the first hole of the first central portion of the planar portion of the ring member.

12. The vehicular camera according to claim 11, further comprising:
a metallic first shield attached to the ring member and facing the first surface of the circuit board and the fourth surface of the planar portion of the ring member, wherein
the first shield has a second central portion in which a second hole corresponding to the first hole of the planar portion of the ring member is formed.

13. The vehicular camera according to claim 12, wherein
the first shield has a shield planar portion, and
a third hole through which the first projection portion of the ring member penetrates, a fourth hole through which the second projection portion of the ring member penetrates, a fifth hole through which the third projection portion of the ring member penetrates, and a sixth hole through which the fourth projection portion of the ring member penetrates are formed in the shield planar portion of the first shield.

14. The vehicular camera according to claim 13, wherein
the first projection portion, the second projection portion, the third projection portion, and the fourth projection portion of the ring member are connected to the first surface of the circuit board via an adhesive.

15. The vehicular camera according to claim 12, further comprising:
a metallic second shield disposed to surround at least the imaging element and the circuit board inside the housing, wherein
the first shield is electrically connected to the second shield.

16. The vehicular camera according to claim 1, further comprising:
a resin member disposed at least between the second surface of the circuit board and the fourth end portion of the housing inside the housing.

17. The vehicular camera according to claim 1, further comprising:
a connector connection portion disposed on the second surface of the circuit board; and
a connector that has a first connector end portion and a second connector end portion disposed opposite to the first connector end portion, and is disposed on the fourth end portion of the housing, wherein
the first connector end portion of the connector is electrically connected to the connector connection portion on the second surface of the circuit board.

18. The vehicular camera according to claim 17, wherein
the connector is a coaxial connector.

19. The vehicular camera according to claim 1, wherein
in the first welded portion, the first portion of the ring member and the at least a part of the third end portion of the housing are welded by a laser over the entire periphery around the optical axis, the first portion being disposed over the entire periphery around the optical axis, and
in the second welded portion, the second portion of the ring member and the at least a part of the second end portion of the lens barrel are welded by a laser over the entire periphery around the optical axis, the second portion being disposed over the entire periphery around the optical axis.

20. The vehicular camera according to claim 19, wherein
the lens barrel is formed of a first resin having a first light absorptance,
the housing is formed of a second resin having a second light absorptance, and
the ring member is formed of a third resin having a third light absorptance.
